(19) United States
(12) Patent Application Publication
(10) Pub. No.: US 2025/0178161 A1
(43) Pub. Date: Jun. 5, 2025

(54) SLIDE HAMMER PLIERS

(71) Applicant: Snap-on Incorporated, Kenosha, WI (US)

(72) Inventors: Craig Bashleben, Winthrop Harbor, IL (US); Allen M. Hutchison, Beach Park, IL (US); Kyle J. Coleman, Katy, TX (US)

(73) Assignee: Snap-on Incorporated, Kenosha, WI (US)

(21) Appl. No.: 18/529,045

(22) Filed: Dec. 5, 2023

(51) Int. Cl. B25B 7/12; B25B 7/14

(52) U.S. Cl. CPC B25B 7/12; B25B 7/14

(57) ABSTRACT

A slide hammer attachment with pliers-type or clamping members having a threaded clamping mechanism for securely gripping a fastener or work piece. The tool, when coupled to a slide hammer, may provide a secure clamping force, co-axial with an axis of a slide hammer shaft, on or about a fastener or work piece. The clamping force may facilitate removal of the work piece from a fitting with a pulling-type force.

### TECHNICAL FIELD OF THE INVENTION

The present invention relates generally to pliers, more specifically to a slide hammer attachment having pliers with a threaded clamping mechanism for securely gripping an object, component of an assembly or a fastener of any type.

### BACKGROUND OF THE INVENTION

Assembled components often require a significant applied pulling force for removal or disassembly. Typical pullers and other standard tools may not be able to remove certain components due to adjacent or nearby equipment or other components obstructing access. Additionally, many objects exist for which traditional pullers or standard tools cannot sufficiently grip and successfully remove due to the large amounts of gripping and pulling force needed for removal.

Slide hammers typically include a sliding mass referred to as a “hammer body” that axially slides along a shaft to impact a stop that is affixed-to or part-of the shaft. The opposite end of the shaft serves as an attachment point. Upon impact with the stop, inertia from the mass is transferred to the shaft, generating an axial impacting-type force on the shaft in the direction the mass slid. By coupling the attachment point to an object, a pulling force is applied to the object. Application of a pulling force is particularly advantageous when a push or pry force cannot be applied to the other side of the object.

Locking pliers have been coupled to and used with slide hammers to grasp, lock onto, and forcefully remove components. These combinations, however, may not properly align the axis of the component with the axis of the slide hammer weight/shaft or the axial length of the pliers, often having the pliers at an offset axis or a non-parallel orientation relative to the slide hammer. Such configurations decrease the effectiveness of the sliding force applied by the hammer weight. Further, use of known locking pliers can be cumbersome, and the geometry of conventional locking pliers is not well-suited for tight-fitting, or crowded spaces.

### SUMMARY OF THE INVENTION

The present invention relates broadly to a slide hammer attachment having pliers with a threaded clamping or locking mechanism for securely gripping a fastener or work piece to be removed. The pliers, when attached to a slide hammer, provide a co-axial, secure clamping force on a fastener or workpiece, facilitating the forceful removal of the workpiece with the slide hammer. The threaded mechanism may include a threaded shaft about which the jaws of the pliers may be coupled and tensioned to sufficiently grip the workpiece. The threaded mechanism may alternatively include a tensioning bolt coupled to and operable on one or more of the jaws to create the clamping force on the work piece.

According to an embodiment, a tool is disclosed. The tool may include a base having a through hole, first and second clamping bodies pivotably coupled to the base, and a shank having distal and proximal ends. The proximal end may be threadedly coupled to the base. Rotation of the base with respect to the shank in a first rotational direction may cause the first and second clamping bodies to pivot in a clamping or locking direction. Conversely, rotation of the base in a second rotational direction may cause the first and second clamping bodies to pivot in an unclamping or unlocking direction.

According to another embodiment, a tool is disclosed including a base with a through hole and first and second wings and a shank threadedly coupled to the through hole of the base. A yoke may or may not be coupled to a distal end of the shank. First and second clamping bodies, each having a clamping or gripping surface, may be pivotably coupled to the yoke by a yoke pin. Rotation of the base with respect to the shank in a first rotational direction may cause the first and second clamping bodies to pivot about the yoke pin in a clamping or locking direction, and rotation of the base in a second rotational direction may cause the first and second clamping bodies to pivot in an unclamping or unlocking direction.

According to an embodiment, a tool adapter is disclosed. The tool adapter may include a base having distal and proximal ends, a pocket extending from the first end, and a first jaw extending from the first end. A second jaw may be disposed in the pocket and may be pivotably coupled to the base. The second jaw may include distal and proximal portions and a foot portion extending from the proximal portion. A shank may be threadedly coupled to the base, extending into the pocket and adapted to engage the foot portion of the second jaw. Threading the shank in a first rotational direction may cause the proximal portion of the second jaw to pivot towards the first jaw, and threading the shank in a second rotational direction may cause the first jaw to pivot away from the first jaw.

### BRIEF DESCRIPTION OF THE DRAWINGS

For purposes of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is an isometric perspective view of an exemplar slide hammer assembly, with a two-piece hammer body, according to an embodiment of the present invention.

FIG. 2A is an isometric perspective view of an exemplar tool for use with a slide hammer, according to an embodiment of the present invention.

FIG. 2B is a partial exploded isometric perspective view of the tool of FIG. 2A, according to an embodiment of the present invention.

FIG. 3A is an isometric perspective view of another exemplar tool for use with a slide hammer, according to an embodiment of the present invention.

FIG. 3B is a partial exploded isometric perspective view of the tool of FIG. 3A, according to an embodiment of the present invention.

FIG. 4A is an isometric perspective view of another exemplar tool for use with a slide hammer, according to an embodiment of the present invention.

FIG. 4B is a partial side view of the tool of FIG. 4A, according to an embodiment of the present invention.

FIG. 4C is a partial exploded isometric perspective side view of the tool of FIG. 4A, according to an embodiment of the present invention.

FIG. 5A is an isometric perspective view of another exemplar tool for use with a slide hammer, according to an embodiment of the present invention.

FIG. 5B is an isometric perspective view of the tool of FIG. 5A, according to an embodiment of the present invention.

FIG. 5C is a partial exploded isometric perspective view of the tool of FIG. 5A, according to an embodiment of the present invention.

FIG. 6A is an isometric perspective view of another exemplar tool for use with a slide hammer, according to an embodiment of the present invention.

FIG. 6B is an exploded isometric perspective view of the tool of FIG. 6A, according to an embodiment of the present invention.

FIG. 6C is a side view of the tool of FIG. 6A, according to an embodiment of the present invention.

FIG. 6D is a front sectional view of the tool of FIG. 6A, taken across line A-A in FIG. 6C, according to an embodiment of the present invention.

FIG. 7A is an isometric perspective view of another exemplar tool for use with a slide hammer, according to an embodiment of the present invention.

FIG. 7B is an exploded isometric perspective view of the tool of FIG. 7A, according to an embodiment of the present invention.

FIG. 7C is a side view of the tool of FIG. 7A, according to an embodiment of the present invention.

FIG. 7D is a sectional side view of the tool of FIG. 7A, taken across line B-B in FIG. 7C, according to an embodiment of the present invention.

FIG. 8A is a front view of another exemplar tool for use with a slide hammer, according to an embodiment of the present invention.

FIG. 8B is a isometric perspective view of the tool of FIG. 8A, according to an embodiment of the present invention.

FIG. 8C is an exploded isometric perspective view of the tool of FIG. 8A, according to an embodiment of the present invention.

FIG. 9A is an exploded isometric perspective view of another exemplar tool for use with a slide hammer, according to an embodiment of the present invention.

FIG. 9B is a sectioned view of the tool of FIG. 9A, according to an embodiment of the present invention.

FIG. 10 is a front view of an exemplar tool including a slide hammer, according to an embodiment of the present invention.

### DETAILED DESCRIPTION

While the present invention is susceptible of embodiments in many different forms, there is shown in the drawings, and will herein be described in detail, embodiments of the invention, including a preferred embodiment, with the understanding that the present disclosure is to be considered as an exemplification of the principles of the present invention and is not intended to limit the broad aspect of the invention to any one or more embodiments illustrated herein. As used herein, the term “present invention” is not intended to limit the scope of the claimed invention but is instead used to discuss exemplary embodiments of the invention for explanatory purposes only.

The present invention relates broadly to a slide hammer attachment with pliers-type or clamping/spreading members or having a threaded clamping/spreading mechanism for securely gripping a fastener or work piece. The tool, when coupled to a slide hammer, may provide a secure clamping/spreading force, that may be co-axial with an axis of a slide hammer shaft, on or about a fastener or work piece, of which the clamping/spreading force increases as the slide hammer is actuated. The clamping force may facilitate removal of the work piece from a fitting with a pulling-type force. The threaded mechanism may include a threaded shaft, to which the tool head may be coupled and may be tensioned to sufficiently grip the workpiece. The threaded mechanism may alternately include a tensioning bolt coupled to and operable on one or more of the jaws of the attachment to create a clamping/spreading force on or about the work piece. The jaw geometries and serrations/engagements are not limited to the designs shown, but may be specific to the application or need for working on any flat, round, or irregularly shaped workpiece.

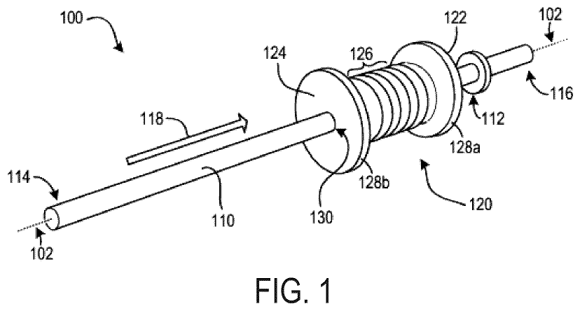

Referring to FIG. 1, an embodiment of the present invention broadly comprises a slide hammer assembly 100 that may include a hammer body 120 axially slidable along a longitudinal slide shaft 110, such as, but not limited to, a metal rod. A first end 114 of the shaft 110 may serve as an attachment point for coupling the slide hammer assembly 100 to an attachment, as described herein, or another object being worked upon, and may be threaded, beveled, male, female, or the like. A second end 116 of the shaft 110 may include or be coupled to a handle (not shown).

The hammer body 120 may include a through bore 130 extending longitudinally therethrough that slidably receives the slide shaft 110. The through bore 130 may have cross-sectional dimensions, orthogonal to a long axis 102 of the slide shaft 110 and the hammer body 120, slightly larger than the cross-sectional dimensions of the external “slide” surface of the slide shaft 110, to allow the hammer body 120 to be axially slidable on the slide shaft 110.

The hammer body 120 may have a middle section 126, which is illustrated as cylindrical, but may have any cross-sectional configuration. The outer surface of the middle section 126 may be ribbed, knurled, or textured to provide a griping or handhold portion. The hammer body 120 may also have flanged ends 128a, 128b that extend radially outwardly from the longitudinal axis 102 to have a larger cross-section than the middle section 126. The flanges 128a and 128b may help protect a user's hand and/or fingers when gripping the middle section 126 to slide the hammer body 120 along the shaft 110.

A slide stop 112 may be coupled to or integrally part of the shaft 110, proximate to the second end 116. The slide stop 112 may have cross-sectional dimensions, orthogonal to the axis 102, larger than the cross-sectional dimensions of the through bore 130. The hammer body 120 may axially slide along the shaft 110 in a direction 118 until an impact surface 122 of the hammer body 120 impacts with the slide stop 112, producing an axial force along the shaft 110 in the direction 118. Optionally, a second stop (not shown) may be included proximate to the first end 114, to impede a non-impact surface 124 of the hammer body 120 from sliding past the first end 114, thus preventing the hammer body 120 from being inadvertently removed from the shaft 110.

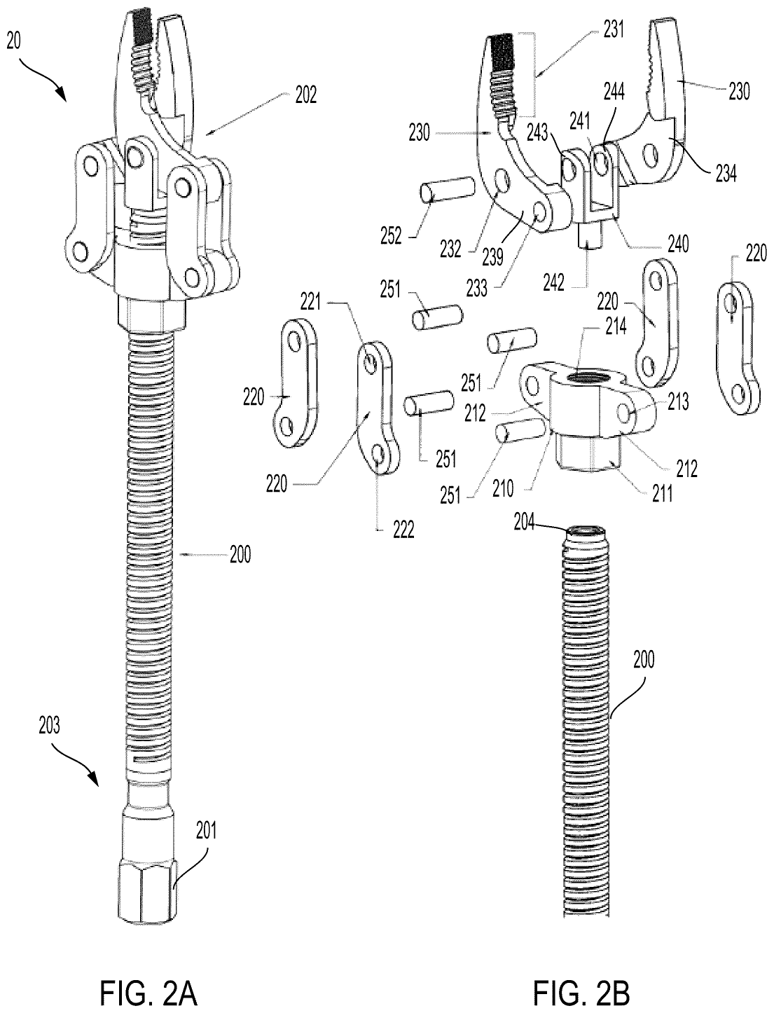

Referring generally to FIGS. 2A and 2B, a tool 20 for use with a slide hammer, such as the slide hammer of FIG. 1 described above, is depicted, according to an embodiment of the present invention. The tool 20 may be a pliers-type device having a tool head 202 disposed at or on a distal end of a shank 200 and a coupling 201 at a proximal end 203 of the shank 200 adapted to couple to the shaft of a slide hammer, such as described above, or another tool. The coupling 201 may be hexagonally shaped and adapted to be engageable with a tightening tool, such as a wrench. The shank 200 may include an exterior threaded surface extending the length of the shank 200, or a portion thereof. The coupling 201 may be or include a male or female joint and may be threaded, beveled, or otherwise adapted to couple to the shaft of a slide hammer, or another tool.

According to an embodiment, the tool head 202 may generally include a base 210 coupled to the distal end of the shank 200. The base 210 may include threaded through hole 214 extending through the base and adapted to threadedly engage the shank 200. A proximal end 211 of the base 210 may include an angled or beveled exterior surface, like that of a hexagonal nut, adapted to receive a wrench or other tightening device for threadably coupling the base 210 to the shank 200. The base 210 may further include opposing wings 212 extending from sides of the base 210. The wings 212 may include pin holes 213 adapted to respectively receive and retain link pins 251.

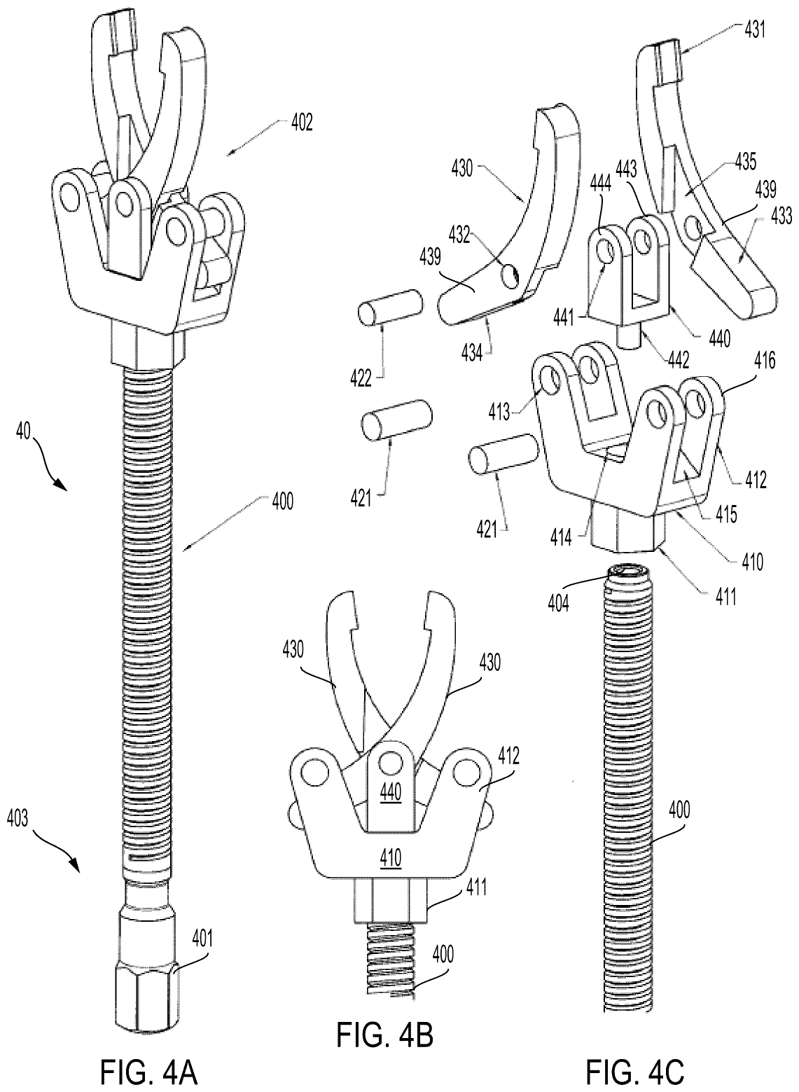

According to an embodiment, the base 210 may be pivotably coupled to one or more plier-type jaws, such as first and second jaw bodies 230. The first and second bodies 230 may be generally “L” shaped jaws having a clamping surface 231, adapted for securely gripping a work piece, and a foot portion 239 extending laterally from the body 230. The clamping surface 231 may include gripping portions, a smooth surface, or opposing grooves (like those shown in FIG. 4A-C). The first and second jaw bodies 230 may further each include or define a link pivot hole 233 and a yoke pivot hole 232. Each of the first and second jaw bodies 230 may include a pocket 234 formed on an internally facing surface of the first and second bodies 230. The pocket 234 may be sized and shaped to accommodate the width of the opposing body, aligning the clamping surfaces 231 and allowing for pivoting of the first and second jaw bodies 230, as described below.

According to an embodiment, the first and second bodies 230 may be coupled to the base 210 by respective link bars 220. Each link bar 220 may include at least two link pin holes 221, 222 adapted to respectively receive the link pins 251 to pivotably couple the link bars 220 to the first and second jaw bodies 230 (through the link pivot holes 233) and the wings 212 of the base 210 (through pin holes 213), respectively. The link pins 251 may be sized and shaped to securely engage and be retained in the link pin holes 221, 222, for example by press-fit or the like. Alternately, the link pins may be secured by threaded connection, ball detent, cotter pins, retaining rings, or mushroom deformation (such as with a riveting operation). The pin hole 213 of the base 210 may be sized and shaped nominally larger than the link pins 251 to allow the link bars 220 to respectively pivot about the wings 212 of the base 210. While the embodiment shown in FIGS. 2A-B depicts a tool head 202 using four link bars 220, two thicker link bars 220 with slots at the pin holes may alternately be coupled to the base 210 at each wing 212.

According to an embodiment, a yoke 240 may be disposed at or near the distal end of the shank 200. The yoke 240 may or may not include a dowel portion 242 and may include two opposing projections 243, 244, each with a yoke hole 241. The yoke 240 may be adapted to receive therein the first and second jaw bodies 230 between the projections 233, 234. The dowel portion 242 may be sized and shaped to fit securely within a cavity 204 in the distal end of the shank 200. The dowel portion 242 may be coupled to the shank 200 by, for example, friction, interference or press fit, adhesive, threaded, or another secure coupling mechanism.

The yoke 240 may be coupled to the first and second jaw bodies 230 by a yoke pin 252 axially disposed through the yoke pivot holes 232 of the first and second jaw bodies 230 and the yoke holes 241 of the yoke 240. The yoke pin 252 may be sized and shaped to securely engage and be retained in the yoke holes 241 of the yoke, for example by a press, friction or interference fit, threaded connection, ball detent, cotter pins, snap-rings, mushroom deformation (such as with a riveting operation), or the like. The yoke pivot holes 232 of the first and second jaw bodies 230 may be sized and shaped nominally larger than yoke pin 252 to allow the first and second jaw bodies 230 to pivot about the yoke pin 252 while the yoke pin 252 remains securely engaged with the yoke holes 241 of the yoke 240, or vice versa.

In operation, according to an embodiment, the tool 20 may rely on the engagement of the base 210 with the shank 200 as a screw-driven tensioner driving the clamping and unclamping forces of the first and second bodies 230. For example, as the base 210 is rotated in a first rotational direction (e.g., clockwise) about the threads of the shank 200, the base 210 may travel away from the distal end of the shank 200 towards the proximal end 203. As the base 210 travels axially towards the proximal end 203, the link bars 220 pivot about wings 212 of the base 210 supplying a downward force that causes the first and second jaw bodies 230 to pivot about link pins 251 and the yoke pin 252 to draw the gripping portions 231 together in a clamping direction. Moreover, proximal end 211 may be used to either hand-tighten, or tightened with a tool (e.g., wrench) to apply creating clamping force between first and second jaw bodies 230.

According to an embodiment, the operation of the tool 20 provides a clamping action with more force than traditional pliers. In addition, the tool 20 may clamp harder on the work piece when pulling force is applied to the shank 200. For example, when used in conjunction with a slide hammer, as discussed above, the pulling force may be substantially aligned with the center of the first and second jaw bodies 230 allowing the work piece to be removed with greater ease due to greater gripping force and slide hammer action.

Conversely, rotating the base 210 in a second rotational direction (e.g., counterclockwise) may cause the base 210 to travel towards the distal end of the shank 200. As the base 210 travels axially towards the distal end of the shank 200, the link bars 220 may pivot about the wings 212 causing an upward force that causes the first and second jaw bodies 230 to pivot about the link pins 251 and the yoke pin 252 pushing the jaw portions 232 away in an unclamping direction. One or more linear and/or torsional return spring may be incorporated into the design to facilitate smoother jaw rotation in the unclamping direction.

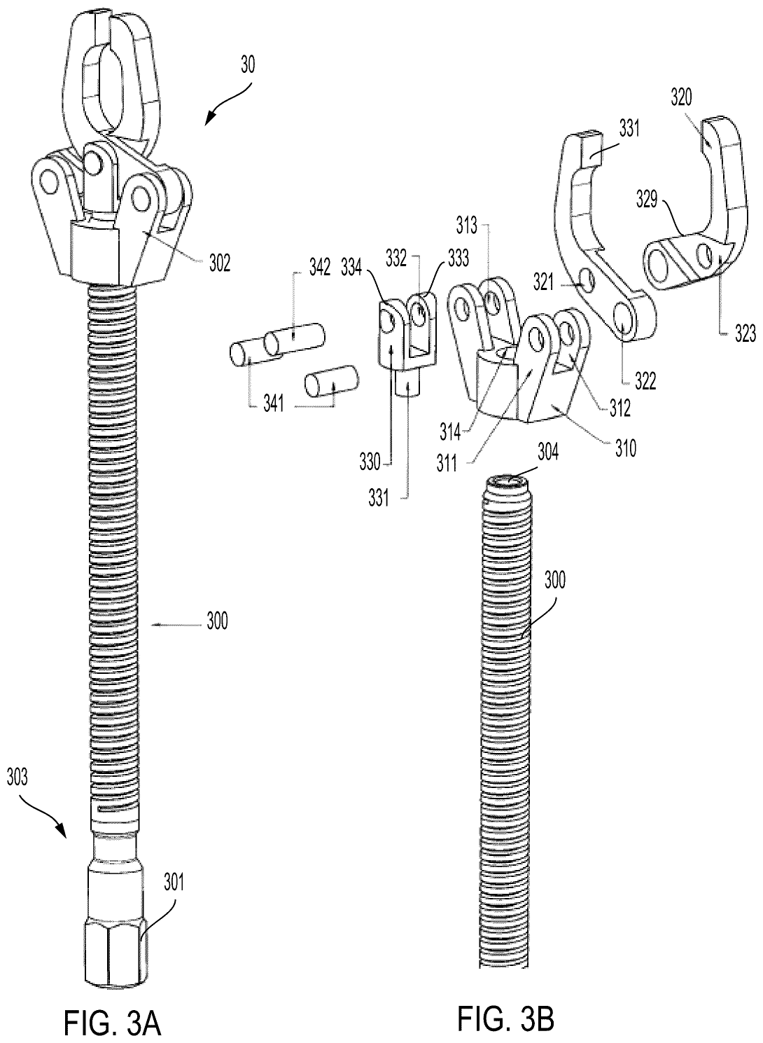

Referring generally to FIGS. 3A-B, another tool 30 for use with a slide hammer, such as, the slide hammer of FIG. 1 described above, is depicted. according to an embodiment of the present invention. The tool 30 may be a pliers-type device having a coupling 301 adapted to couple to the shaft of a slide hammer, or another tool. The tool 30 depicted in FIGS. 3A-B may operate similarly to the tool 20 depicted in FIGS. 2A-B. The tool 30, however, may provide a direct coupling of first and second bodies 320 to a base 310.

A threaded shank 300 may include a coupling 301 disposed at a proximal end 303 of the shank. The coupling feature 301 may be adapted to couple the tool 30 to the shaft of a slide hammer, such as describe above (see e.g., FIG. 1), or another tool. The coupling 301 may be hexagonally shaped to allow engagement with a tightening tool, such as a wrench. A tool head 302 may be disposed at a distal end of the shank 300. According to an embodiment, the tool head 302 may generally include a base 310 coupled to the distal end of the shank 300. The base 310 may include a threaded through hole 314 extending through the base 310 and adapted to threadedly engage the shank 300. The base 310 may further include opposing wings 311 respectively extending from the sides of the base 310. Each of the wings 311 may include one or more wing projections 312 cooperatively forming yokes. The wing projections 312 may include pin holes 313 respectively adapted to securely receive and retain wing pins 341.

According to an embodiment, the base 310 may be pivotably coupled to one or more jaws, such as the first and second jaw bodies 320. The first and second jaw bodies 320 may be generally “L” shaped jaws having a clamping surface 331, adapted for securely gripping a work piece, and a foot portion 329 extending laterally from the body 320. The clamping surface 331 is not limited to the design shown, but may be specific to the application or need for any working on any flat, round, or irregularly shaped workpiece. The first and second jaw bodies 320 may further include or define a wing pivot hole 322 and a yoke pivot hole 321. Each of the first and second bodies 320 may include a pocket 323 formed on an internally facing surface of the first and second bodies 320. The pocket 323 may be sized and shaped to accommodate the width of the opposing body, aligning the clamping surfaces 331 and allowing for the pivoting of the first and second jaw bodies 320, as described below.

According to an embodiment, the first and second jaw bodies 320 may be respectively coupled to and disposed between the wing projections 312. The wing pins 341 may be respectively disposed through the pin holes 313 and the wing pivot holes 322 of the first and second jaw bodies 320. The wing pins 341 may be sized and shaped to securely engage and be retained in the pin holes 313, for example by a press, friction or interference fit, threaded connection, ball detent, cotter pins, snap-rings, mushroom deformation (such as with a riveting operation) or the like. The wing pivot holes 322 of the first and second bodies 320 may be sized and shaped nominally larger than the wing pins 341 to allow the first and second bodies 230 to pivot about the wings 312 of the base 310.

According to an embodiment, a yoke 330 may be disposed at or near the distal end of the shank 300. The yoke 330 may or may not include a dowel portion 331 and two opposing projections 333, 334 each with yoke holes 332. The yoke 330 may be adapted to respectively receive the first and second jaw bodies 320 between the projections 333, 334. If included, the dowel portion 331 may be sized and shaped to fit securely within a cavity 304 in the distal end of the shank 300. The dowel portion 331 may be coupled to the shank 300 by friction, interference, or press fit, adhesive, threaded or another secure coupling mechanism.

The yoke 330 may be coupled to the first and second jaw bodies 320 by a yoke pin 342 disposed through the yoke pivot holes 321 of the first and second jaw bodies 320 and the yoke holes 332 of the yoke 330. The yoke pin 342 may be sized and shaped to securely engage and be retained in the yoke holes 332 of the yoke 330, for example by a press, friction or interference fit, threaded connection, ball detent, cotter pins, snap-rings, mushroom deformation (such as with a riveting operation) or the like. The yoke pivot holes 321 of the first and second jaw bodies 320 may be sized and shaped nominally larger than the yoke pin 342 to allow the first and second jaw bodies 320 to pivot about the yoke pin 342 while the yoke pin 342 remains securely engaged with the yoke holes 332 of the yoke 330 or vice versa.

In operation, according to an embodiment, the tool 30 may rely on the engagement of the base 310 with the shank 300 as a screw-driven tensioner driving the clamping and unclamping forces of the first and second jaw bodies 320. As the base 310 is rotated in a first rotational direction (e.g., clockwise) about the threads of the shank 300, the base 310 may travel away from the distal end of the shank 300 towards the proximal end 303. As the base 310 travels axially towards the proximal end 303, the first and second jaw bodies 320 may pivot about the wings 311 of the base 310 causing the first and second jaw bodies 320 to pivot about yoke pin 342 and draw the clamping surfaces 331 together in a clamping direction. The base may include a hexagonal holster (not shown) similar to the proximal end 311 in the embodiment of tool 20, the hexagonal holster may be affixed to base 310 and it may be used to either hand-tighten, or tightened with a tool (e.g., wrench) to apply clamping force between first and second jaw bodies 320.

Conversely, rotating the base 310 in a second rotational direction (e.g., counterclockwise) may cause the base 310 to travel towards the distal end of the shank 300. As the base 310 travels axially towards the distal end of the shank 300, the first and second bodies 320 may pivot about the yoke pin 342, causing the first and second jaw bodies 320 to rotate relative to the wings 311 pulling the clamping surfaces 331 away in an unclamping direction. One or more linear and/or torsional return springs may be incorporated into the design to facilitate smoother jaw rotation in the unclamping direction.

Referring generally to FIGS. 4A-C, a tool 40 for use with a slide hammer, such as the slide hammer of FIG. 1 described above, is depicted according to an embodiment of the present invention. The tool 40 may be a pliers-type device having a coupling feature 401 adapted to couple to the shaft of a slide hammer, integrated with a slide hammer mechanism, or another tool. The tool 40 depicted in FIGS. 4A-C may operate similarly to the tools 20 and 30, previously described. The tool 40, however, may include first and second jaw bodies 430 that include pivot holes 432 about which the first and second jaw bodies 430 may pivot.

A threaded shank 400 may include a coupling 401 disposed at a proximal end 403 of the shank 400. The coupling feature 401 may be adapted to couple the tool 40 to the shaft of a slide hammer (FIG. 1), integrated with a slide hammer mechanism, or another tool. The coupling 401 may be hexagonally shaped to allow engagement with a tightening tool, such as a wrench. A tool head 402 may be disposed at a distal end of the shank 400. According to an embodiment, the tool head 402 may generally include a base 410 coupled to the distal end of the shank 400. The base 410 may include a threaded through hole 414 extending through the base 410 and adapted to threadedly engage the shank 400. A proximal end 411 of the base 410 may include an angled or beveled exterior surface, like that of a nut, adapted to receive a wrench or other tightening device for rotating the base 410 about the shank 400. The base 410 may further include opposing wings 412 respectively extending from the sides of the base 410. Each of the wings 412 may include one or more wing projections 416 and a base portion 415. The wing projections 416 may respectively include pin holes 413 adapted to securely receive and retain wing pins 421.

According to an embodiment, the base 410 may be pivotably coupled to one or more plier jaws, such as the first and second jaw bodies 430. The first and second jaw bodies 430 may be generally arcuate shaped jaws having a clamping surface 431, adapted for securely gripping a work piece, and a foot portion 439. The foot portion 439 may include opposing first and second surfaces 433,434. The first surface 433 may be disposed on a concave portion of the body 430 and the second surface 434 may be disposed on the opposite, convex surface of the body 430. The clamping surface 431 may or may not include a groove, such that when opposing grooves 431 are drawn together, the grooves 431 are adapted to receive a shaft or curved workpiece. Additionally, the clamping surface 431 may include toothed portions (FIG. 2A-B), or a smooth surface. Alternatively, clamping surface 431 may be flat with or without grooves similar to the clamping surface 231 or clamping surface 331.

The first and second bodies 430 may further include or define respective pivot holes 432. Each of the first and second bodies 430 may include a pocket 435 formed on an internally facing surface of the first and second bodies 430. The pocket 435 may be sized and shaped to accommodate the width of the opposing body, aligning the clamping surfaces 431 and allowing for the pivoting of the first and second bodies 430 as described below.

According to an embodiment, the first and second bodies 430 may be disposed between the wing projections 416. The wing pins 421 may be disposed through the pin holes 413. The wing pins 421 may be sized and shaped to securely engage and be retained in the pin holes 413, for example by a press, friction or interference fit, cotter pins, snap-rings, mushroom deformation (such as with a riveting operation) or the like. The wing pins 421 may be adapted to retain the first and second bodies 430, and particularly the foot portions 439, within the wings 412 when the bodies 430 pivot, as described below.

According to an embodiment, a yoke 440 may be disposed at or near the distal end of the shank 400. The yoke 440 may or may not include a dowel portion 442 and two opposing projections 443, 444 each with yoke holes 441. The yoke 440 may be adapted to receive the first and second jaw bodies 430 between the projections 443, 444. The dowel portion 442 may be sized and shaped to fit securely within a cavity 404 in the distal end of the shank 400. The dowel portion 442 may be coupled to the shank 400 by friction, ball detent, ring, interference, or press fit, adhesive, threaded or another secure coupling mechanism.

The yoke 440 may be coupled to the first and second bodies 430 by a yoke pin 422 disposed through the pivot holes 432 of the first and second bodies 430 and the yoke holes 441 of the yoke 440. The yoke pin 432 may be sized and shaped to securely engage and be retained in the yoke holes 441 of the yoke 440, for example by a press fit or the like. The pivot holes 432 of the first and second bodies 430 may be sized and shaped nominally larger than the yoke pin 422 to allow the first and second bodies 430 to pivot about the yoke pin 422 while the yoke pin 422 remains securely engaged with the yoke holes 441 of the yoke 440 or vice versa.

In operation, according to an embodiment, the tool 40 may rely on the engagement of the base 410 with the shank 400 as a screw-driven tensioner driving the clamping and unclamping forces of the first and second bodies 430. The foot portion 439 of the first and second bodies 430 may selectively engage the base portion 415 or the wing pins 421 retaining the foot portion 439 within the wings 412 of the base 410.

As the base 410 is rotated in a first rotational direction (e.g., clockwise) about the threads of the shank 400, the base 410 may travel away from the distal end of the shank 400 towards the proximal end 403. As the base 410 travels axially towards the proximal end 403, the wing pins 422 may engage the foot portion 439 of the first and second bodies 430, particularly the first opposing surface 433, causing the first and second jaw bodies 430 to pivot about yoke pin 422 and push the clamping surfaces 431 together in a clamping direction. Moreover, proximal end 411 may be used to either hand-tighten, or tightened with a tool (e.g., wrench) to apply clamping force between first and second jaw bodies 430.

Conversely, rotating the base 410 in a second rotational direction (e.g., counterclockwise) may cause the base 410 to travel towards the distal end of the shank 400. As the base 410 travels axially towards the distal end of the shank 400, the foot portion 439 of the first and second bodies 430, particularly the second opposing surface 434, may engage the wing base 415 causing the first and second bodies 430 to pivot about the yoke pin 422 pushing the clamping surfaces away in an unclamping direction. One or more linear and/or torsional return spring may be incorporated in the design to facilitate smoother jaw rotation in the unclamping direction.

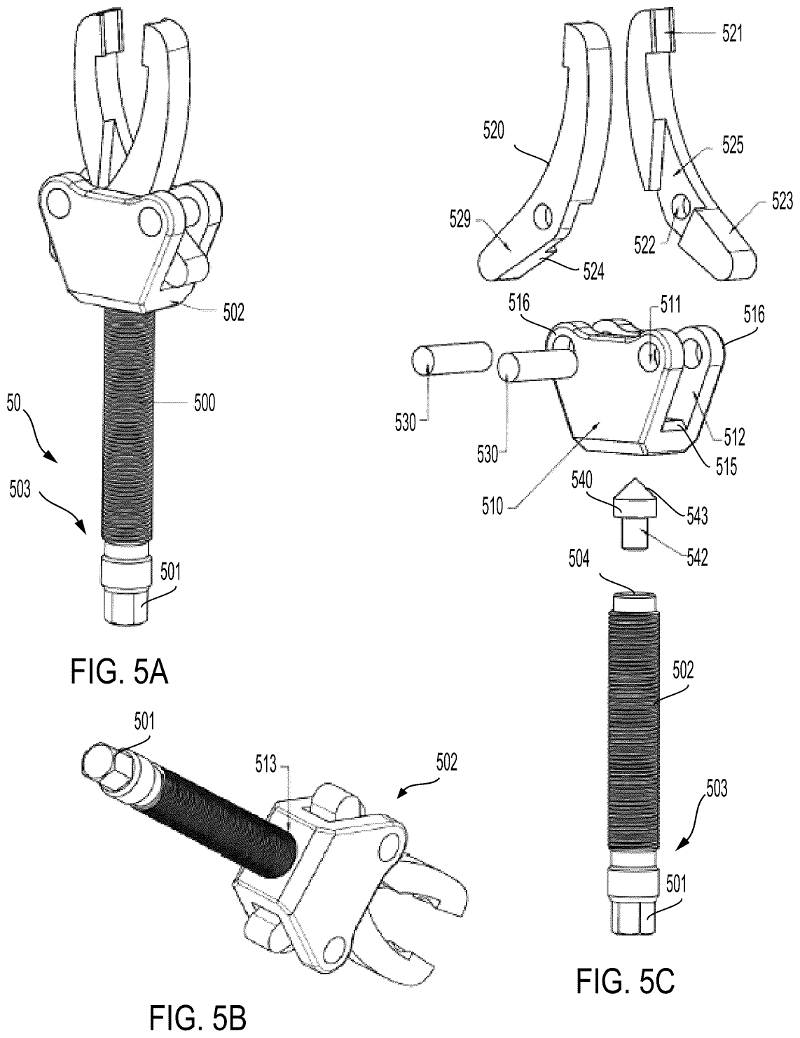

Referring generally to FIGS. 5A-C, a tool 50 for use with a slide hammer, such as the slide hammer of FIG. 1 described above, is depicted according to an embodiment of the present invention. The tool 50 may be a pliers-type device having a coupling feature 501 adapted to couple to the shaft of a slide hammer, integrated with a slide hammer, or another tool. The tool 50 depicted in FIGS. 5A-C may operate similarly to the tools 20, 30, 40 previously described. The tool 50, however, may include a pad 540 about which the first and second bodies 520 may pivot.

A threaded shank 500 may include a coupling 501 disposed at a proximal end 503 of the shank 500. The coupling 501 may be adapted to couple the tool 50 to the shaft of a slide hammer (FIG. 1), integrated with a slide hammer, or another tool. The coupling 501 may be hexagonally shaped to allow engagement with a tightening tool, such as a wrench. A tool head 502 may be disposed at a distal end of the shank 500. According to an embodiment, the tool head 502 may generally include a base 510 coupled to the distal end of the shank 500. The base 510 may include a threaded through hole 513 extending through the base 510 and adapted to threadedly engage the shank 500. The base 510 may further include opposing wings 512 extending from the base 510 and a base portion 515. Each of the wings 512 may include one or more wing projections 516. The wing projections 516 may include pin holes 511 adapted to securely receive and retain wing pins 530.

According to an embodiment, the base 510 may be pivotably coupled to one or more plier jaws, such as the first and second bodies 520. The first and second bodies 520 may be generally arcuate shaped jaws having a clamping surface 521, adapted for securely gripping a work piece, and a foot portion 529. The foot portion 529 may further include opposing first and second surfaces 523, 524. The first surface 523 may be disposed on a concave portion of the body 520 and the second surface 524 may be disposed on the opposite, convex surface of the body 520.

The clamping surface 521 may or may not include a groove or serrations, such that when opposing grooves or serrations on the clamping surface 521 are drawn together, the grooves are adapted to receive a work piece shaft below a cap of head on the work piece. Alternately, the clamping surface 521 may be flat surfaces that are smooth or include toothed portions (see e.g., FIG. 2A-B).

The first and second bodies 520 may further include or define a pivot hole 522, however according to an embodiment, the pivot hole 522 may unnecessary. Each of the first and second jaw bodies 520 may include a pocket 525 formed on an internally facing surface of the first and second jaw bodies 520. The pocket 525 may be sized and shaped to accommodate the width of the opposing body, aligning the clamping surfaces 521 and allowing for the pivoting of the first and second bodies 520 as described below.

According to an embodiment, portions of the first and second bodies 520 may be disposed between the wing wings 512, particularly the foot portion 529. The wing pins 530 may be disposed through the pin holes 511. The wing pins 530 may be sized and shaped to securely engage and be retained in the pin holes 511, for example by a press, friction or interference fit, cotter pins, threaded connection, ball detent, snap-rings, mushroom deformation (such as with a riveting operation) or the like. The wing pins 530 may be adapted to retain the first and second jaw bodies 520, and particularly the foot portions 529 respectively within the wings 512 when the bodies 520 pivot, as described below.

According to an embodiment, a pad 540 may be disposed at or near the distal end of the shank 500. The pad 540 may include a dowel portion 542 and wedge portion 543. The dowel portion 542 may be sized and shaped to fit securely within a cavity 504 in the distal end of the shank 500. The dowel portion 542 may be coupled to the shank 500 by friction, interference, or press fit, adhesive, ball detent, ring, threaded or another secure coupling mechanism. The wedge portion 543 may be substantially conical, curved, flat, or otherwise angled to provide a fulcrum-like engagement with the first and second bodies 520, as described below.

In operation, according to an embodiment, the tool 50 may rely on the engagement of the base 510 with the shank 500 as a screw-driven tensioner driving the clamping and unclamping forces of the first and second bodies 520. The foot portion 529 of the first and second bodies 520 may selectively engage the base portion 515 or the wing pins 530 retaining the foot portion 529 within the wings 512 of the base 510.

As the base 510 is rotated in a first rotational direction (e.g., clockwise) about the threads of the shank 500, the base 510 may travel away from the distal end of the shank 500 towards the proximal end 503. As the base 510 travels axially towards the proximal end 503, the wing pins 530 may engage the foot portion 529 of the first and second bodies 520, particularly the first opposing surface 523, causing the first and second bodies 520 to pivot about the wedge portion 543 and push clamping surfaces 521 together in a clamping direction.

Conversely, rotating the base 510 in a second rotational direction (e.g., counterclockwise) may cause the base 510 to travel towards the distal end of the shank 500. As the base 510 travels axially towards the distal end of the shank 500, the foot portion 529 of the first and second bodies 520, particularly the second opposing surface 524, may be engaged by the wedge portion 543 of the pad 510 causing the first and second bodies 520 to pivot and pushing the clamping surfaces away in an unclamping direction. One or more linear and/or torsional return spring may be incorporated in the design to facilitate smoother jaw rotation in the unclamping direction.

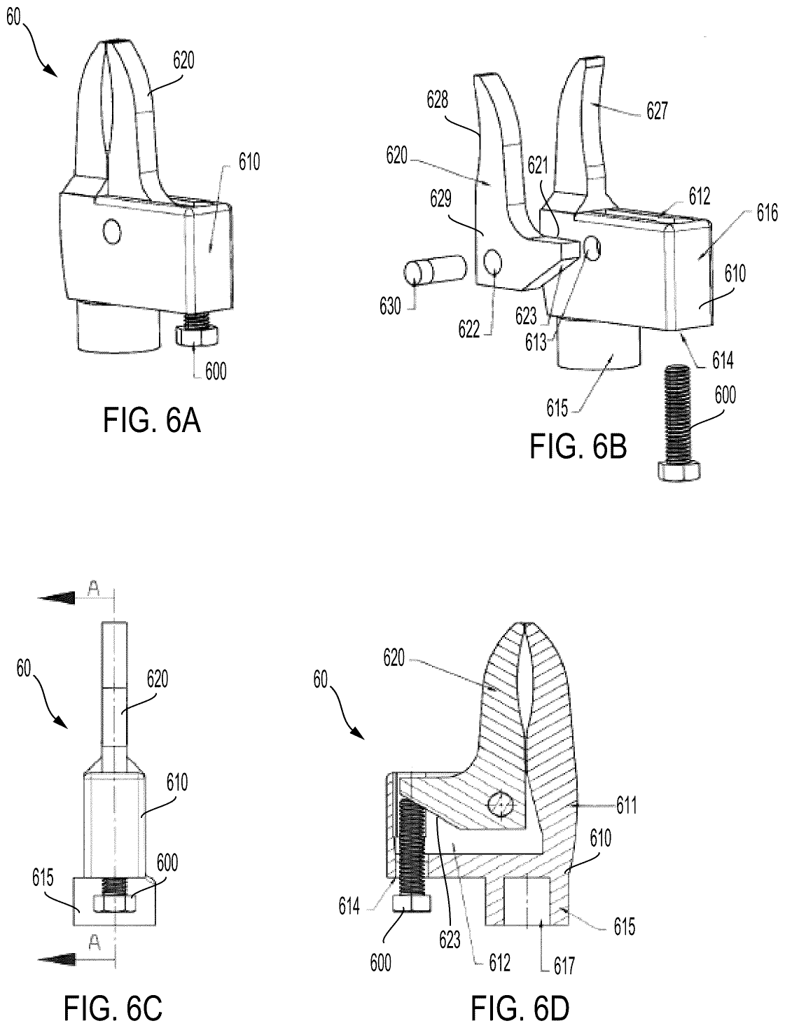

Referring generally to FIGS. 6A-D, a tool 60 for use with a slide hammer, such as the slide hammer of FIG. 1 described above, is depicted according to an embodiment of the present invention. The tool 60 may be a pliers-type device having a coupling feature adapted to couple to the shaft of a slide hammer, or another tool. The tool 60 may include a base 610, one or more jaws such as bodies 611, 620, at least one of which may be pivotable, and a shank 600.

According to an embodiment, the base 610 may have a first end, such as a distal end 616, and a second end, such as proximal end 615. The base 610 may include a pocket 612 extending from the distal end 616 of the base 610. The base 610 may include a first body 611 having a clamping surface 627 and may extend from the distal end 616. According to an embodiment, the first body 611 may form one portion of a jaw and may be integral and/or fixed to the body 610. The base 610 may further include a pin hole 613 adapted to receive a pin 630, as described below.

The pocket 612 may be adapted to receive a second body 620 pivotably coupled to the base 610. The proximal end 615 of the base 610 may include a coupling fixture, such as recess 617 adapted to couple the base 610 to a slide hammer shaft or other tool. While the coupling feature may be depicted as a recess 617, it may be or include a male connector, female connector, press-fit, threaded, or another secure coupling mechanism. The base 610 may further include or define a shank hole 614 adapted to receive the shank 600. According to an embodiment, the shank 600 and shank hole 614 may be threaded, such that rotation of the shank 600 moves the shank 600 through the pocket 612 in a first direction and second direction, for example a clamping direction or an unclamping direction, respectively (as described below). According to an embodiment, the shank 600 may be a bolt, screw or other threaded fastener. Alternatively, shank hole 614 and shank 600 could be on the opposite side to spread the jaws open in an outward direction to engage a workpiece by an internal feature.

The second body 620, according to an embodiment, may be a generally “L” shaped jaw having a clamping surface 628, adapted for securely gripping a work piece, and a foot portion 629 extending laterally from the body 620. The foot portion 629 may include a pivot hole 622 and opposing first and second surfaces 621, 623. The first surface 621 may be disposed on a substantially flat, distal-facing portion of the foot portion 629 and the second surface 623 may be disposed on an opposing, proximally facing surface of the foot portion 629. According to an embodiment, the first surface 621 may be substantially perpendicular to the clamping surface 627 and the second surface 623 may be angled or ramped towards the shank hole 614 and/or the proximal end of tool 60.

In assembly, the second body 620 may be disposed in the pocket 612 of the base 610. The pin 630 may be disposed through the pin hole 613 of the base 610 and the pivot hole 622 of the second body 620. The pin 630 may be sized and shaped to securely engage and be retained in the pin hole 613, for example by press fit or another secure coupling mechanism. The pivot hole 622 of the second body 620 may be sized and shaped nominally larger than the pins 630 to allow the second body 620 to pivot about the pin 630 in the pocket 612 or vice versa. The shank 600 may be threaded into the shank hole 614 and the pocket 612.

In operation, according to an embodiment, the tool 60 may rely on the engagement of the shank 600 with the second body 620 and the base 610 as a screw-driven tensioner driving the clamping and unclamping forces of the second body 620. The shank 600 may selectively engage the foot portion 629 of the second body 620, particularly the second surface 623 as the shank 600 is rotated.

As the shank 600 is rotated in a first rotational direction (e.g., clockwise) the shank 600 may travel further into the pocket 612. As the shank 600 travels into the pocket 612, the shank 600 may engage the ramped/angled second surface 623 of the second body 620, causing second body 620 to pivot about the pin 630 and push the clamping surface 628 of the second body 620 towards the clamping surface 627 of the first body 611 in a clamping direction. The head of the shank 600 may be hexagonal or include flats so it can be engaged with a tightening tool, such as a wrench, to facilitate rotating in the first rotational direction and increase the clamping for applied by the clamping surfaces 627, 628.

Conversely, rotating the shank 600 in a second rotational direction (e.g., counter-clockwise) may cause the shank 600 to travel out of the pocket 612. As the shank 600 travels axially out of the pocket 612, the force exerted on the foot portion 629 of the second body 620 is removed allowing the second body 620 to pivot the clamping surface 628 of the second body 620 away from the clamping surface 627 of the first body 611 in an unclamping direction.

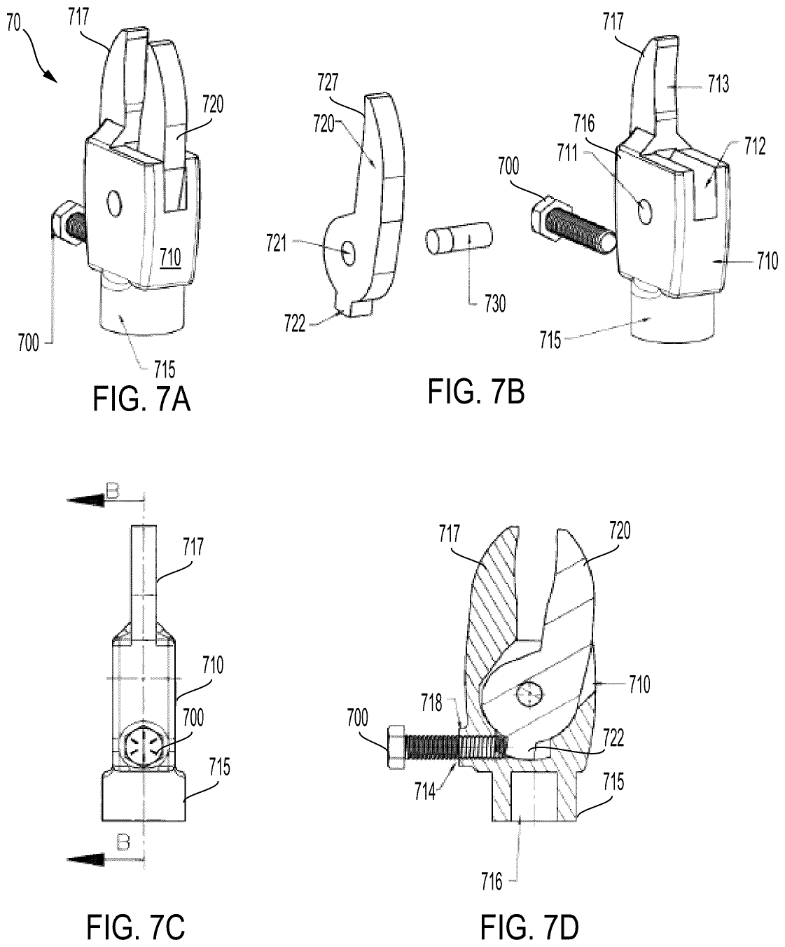

Referring generally to FIGS. 7A-D, a tool 70 for use with a slide hammer, such as the slide hammer of FIG. 1 described above, is depicted according to an embodiment of the present invention. The tool 70 may be a pliers-type device having a coupling adapted to couple to the shaft of a slide hammer, or another tool. The tool 70 may include a base 710, one or more jaws such as bodies 717, 720, at least one of which may be pivotable, and a shank 700.

According to an embodiment, the base 710 may have a first end, such as a distal end 716, and a second end, such as proximal end 715. The base 710 may include a pocket 712 extending from the distal end 716 of the base 710. The base 710 may include a first body 717 having a clamping surface 713 and may extend from the distal end 716. According to an embodiment, the first body 717 may form one portion of a jaw and may be integral and/or fixed to the body 710. The base 710 may further include a pin hole 711 adapted to receive a pin 730, as described below.

The pocket 712 may be adapted to receive a second body 720 pivotably coupled to the base 710. The proximal end 715 of the base 710 may include a coupling fixture, such as recess 716 adapted to couple the base 710 to a slide hammer shaft or other tool. While the coupling feature may be depicted as a recess 716, it may be or include a male connector, female connector, press-fit, threaded, or another secure coupling mechanism. The base 710 may further include or define a shank hole 714 disposed in a projection 718 and extending laterally (e.g., perpendicularly to the first body 717) through a portion of the body 710 to the pocket 712. The shank hole 714 may be adapted to receive the shank 700. According to an embodiment, the shank 700 and shank hole 714 may be threaded such that rotation of the shank 700 moves the shank 700 through the pocket 712 in a first direction and second direction, for example a clamping direction or an unclamping direction, respectively. Alternatively, shank hole 714 and shank 700 could be on the opposite side to spread the jaws open in an outward direction to engage a workpiece by an internal feature. According to an embodiment, the shank 700 may be a bolt, screw or other threaded fastener.

The second body 720, according to an embodiment, may be a generally “finger” shaped jaw having a clamping surface 727, adapted for securely gripping a work piece, and a foot portion, for example tab 722, extending from the body 720, for example at the proximal end of the body 720. The second body 720 may include a pivot hole 721 disposed at or near a center portion of the body 720.

In assembly, the tool 70 may include the second body 720 disposed in the pocket 712 of the base 710. The pin 730 may be disposed through the pin hole 711 of the base 710 and the pivot hole 721 of the second body 720. The pin 730 may be sized and shaped to securely engage and be retained in the pin holes 713, for example by a press, friction or interference fit, cotter pins, snap-rings, mushroom deformation (such as with a riveting operation) or another secure coupling mechanism. The pivot hole 721 of the second body 720 may be sized and shaped nominally larger than the pin 730 to allow the second body 720 to pivot about the pin 730 in the pocket 712 or vice versa. The shank 700 may be threaded into the shank hole 714 and the pocket 712.

In operation, according to an embodiment, the tool 70 may rely on the engagement of the shank 700 with the tab 722 of the second body 720 and the base 70 as a screw-driven tensioner driving the clamping and unclamping forces of the second body 720. Alternatively, shank 700 could apply a force to open the jaws in an outward direction if the shank 700 and the shank hole 714 are disposed on the opposite side of the base 710. The shank 700 may selectively engage the tab 722 of the second body 620 as the shank 600 is rotated.

As the shank 700 is rotated in a first rotational direction (e.g., clockwise) the shank 700 may travel laterally into the pocket 712. As the shank 700 travels into the pocket 712, the shank 700 may engage the tab 722 of the second body 720, causing second body 720 to pivot about the pin 730 and push the clamping surface 727 of the second body 720 towards the clamping surface 713 of the first body 717 in a clamping direction. The head of the shank 700 may have a drive geometry (such as internal hexagonal, external hexagonal, or other effective drive geometry) so it can be engaged with a tightening tool, such as a wrench, to facilitate rotating in the first rotational direction and increase the clamping for applied by the clamping surfaces 717, 720.

Conversely, rotating the shank 700 in a second rotational direction (e.g., counterclockwise) may cause the shank 700 to travel out of the pocket 712. As the shank 700 travels out of the pocket 712, the force exerted on the tab 722 of the second body 720 is removed allowing the second body 720 to pivot the clamping surface 727 of the second body 720 away from the clamping surface 713 of the first body 717 in an unclamping direction.

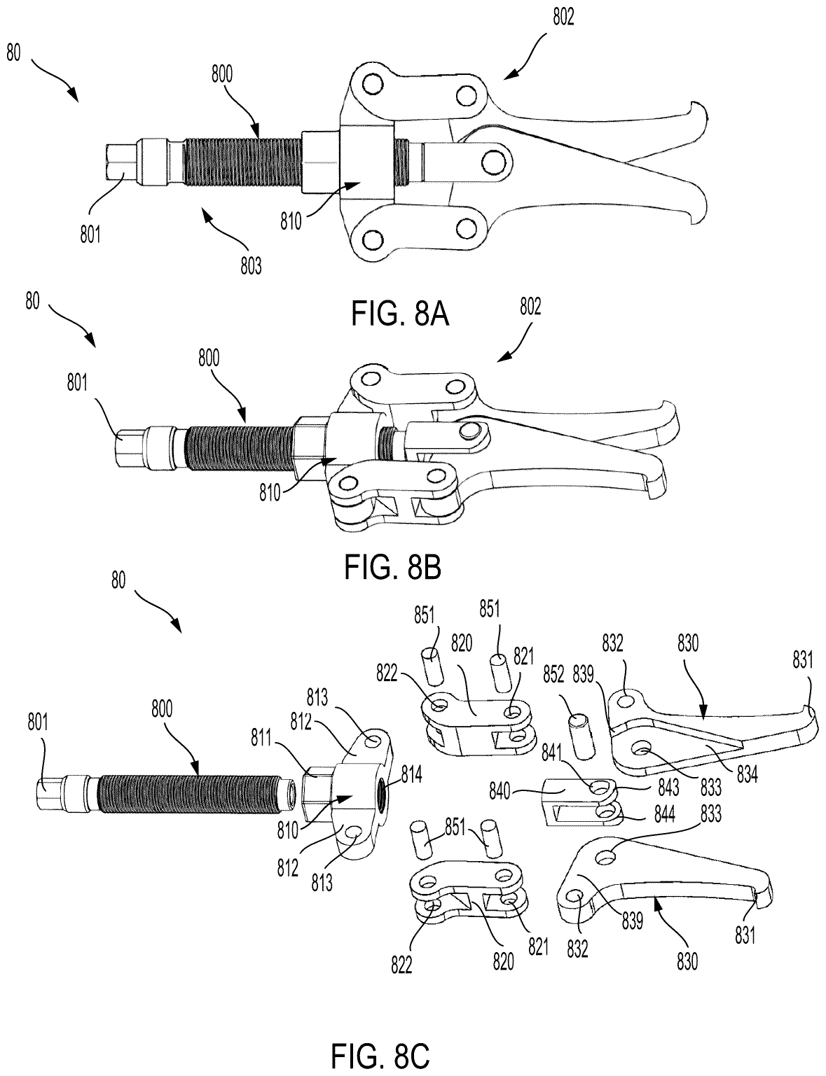

Referring generally to FIGS. 8A, 8B, and 8C, a tool 80 for use with a slide hammer, such as the slide hammer of FIG. 1 described above, is depicted, according to an embodiment of the present invention. The tool 80 may be a pliers-type device having a tool head 802 disposed at or on a distal end of a shank 800 and a coupling 801 at a proximal end 803 of the shank 800 adapted to couple to the shaft of a slide hammer, such as described above, or another tool. The coupling 801 may be hexagonally shaped and adapted to be engageable with a tightening tool, such as a wrench. The shank 800 may include an exterior threaded surface extending the length of the shank 800, or a portion thereof. The coupling 801 may be or include a male or female joint and may be threaded, beveled, or otherwise adapted to couple to the shaft of a slide hammer, or another tool.

According to an embodiment, the tool head 802 may generally include a base 810 coupled to the distal end of the shank 800. The base 810 may include threaded through hole 814 extending through the base and adapted to threadedly engage the shank 800. A proximal end 811 of the base 810 may include an angled or beveled exterior surface, like that of a hexagonal nut, adapted to receive a wrench or other tightening device for threadably coupling the base 810 to the shank 800. The base 810 may further include opposing wings 812 extending from sides of the base 810. The wings 812 may include pin holes 813 adapted to respectively receive and retain link pins 851.

According to an embodiment, the base 810 may be pivotably coupled to one or more plier-type jaws, such as first and second jaw bodies 830. The first and second bodies 830 may be generally “L” shaped jaws having a surface 831, adapted for securely gripping a work piece, and a foot portion 839 extending laterally from the body 830. The clamping surface 831 may include gripping portions, a smooth surface, hooked portions or opposing grooves (like those shown in FIG. 4A-C). The first and second jaw bodies 830 may further each include or define a link pivot hole 833 and a yoke pivot hole 832. Each of the first and second jaw bodies 830 may include a pocket 834 formed on an internally facing surface of the first and second bodies 830. The pocket 834 may be sized and shaped to accommodate the width of the opposing body, extending the surfaces 831 in an outwardly direction to engage a work piece by an internal feature of the work piece, and allowing for pivoting of the first and second jaw bodies 830, as described below.

According to an embodiment, the first and second bodies 830 may be coupled to the base 810 by respective link bars 820. Each link bar 820 may include at least two link pin holes 821, 822 adapted to respectively receive the link pins 851 to pivotably couple the link bars 820 to the first and second jaw bodies 830 (through the link pivot holes 833) and the wings 812 of the base 810 (through pin holes 813), respectively. The link pins 851 may be sized and shaped to securely engage and be retained in the link pin holes 821, 822, for example by press fit or the like. Alternately, the link pins may be secured by threaded connection, ball detent, cotter pins, retaining rings, or mushroom deformation (such as with a riveting operation). The pin hole 813 of the base 810 may be sized and shaped nominally larger than the link pins 851 to allow the link bars 820 to respectively pivot about the wings 812 of the base 810. While the embodiment shown in FIGS. 8A-C depicts a tool head 802 using two link bars 820, four link bars 820 with slots at the pin holes may alternately be coupled to the base 810 at each wing 812.

According to an embodiment, a yoke 840 may be disposed at or near the distal end of the shank 800. The yoke 840 may include two opposing projections 843, 844, each with a yoke hole 841. The yoke 840 may be adapted to receive therein the first and second jaw bodies 830 between the projections 833, 834. The yoke 840 may be coupled to the shank 800 by, for example, friction, interference or press fit, adhesive, threaded, or another secure coupling mechanism.

The yoke 840 may be coupled to the first and second jaw bodies 830 by a yoke pin 852 axially disposed through the yoke pivot holes 832 of the first and second jaw bodies 830 and the yoke holes 841 of the yoke 840. The yoke pin 852 may be sized and shaped to securely engage and be retained in the yoke holes 841 of the yoke, for example by a press, friction or interference fit, threaded connection, ball detent, cotter pins, snap-rings, mushroom deformation (such as with a riveting operation), or the like. The yoke pivot holes 832 of the first and second jaw bodies 830 may be sized and shaped nominally larger than yoke pin 852 to allow the first and second jaw bodies 830 to pivot about the yoke pin 852 while the yoke pin 852 remains securely engaged with the yoke holes 841 of the yoke 840, or vice versa.

In operation, according to an embodiment, the tool 80 may rely on the engagement of the base 810 with the shank 800 as a screw-driven tensioner driving the clamping and unclamping forces of the first and second bodies 830. For example, as the base 810 is rotated in a first rotational direction (e.g., clockwise) about the threads of the shank 800, the base 810 may travel away from the distal end of the shank 800 towards the proximal end 803. As the base 810 travels axially towards the proximal end 803, the link bars 820 pivot about wings 812 of the base 810 supplying a downward force that causes the first and second jaw bodies 830 to pivot about link pins 851 and the yoke pin 852 to draw the surfaces 831 away from each other. One or more linear and/or torsional return spring may be incorporated into the design to facilitate smoother jaw rotation in the unclamping direction.

Conversely, rotating the base 810 in a second rotational direction (e.g., counterclockwise) may cause the base 810 to travel towards the distal end of the shank 800. As the base 810 travels axially towards the distal end of the shank 800, the link bars 820 may pivot about the wings 812. The first and second jaw bodies 830 pivot about the link pins 851 and the yoke pin 852 pulling the jaw portions 832 towards each other. Moreover, proximal end 811 may be used to either hand-tighten, or tightened with a tool (e.g., wrench) to apply creating clamping force between first and second jaw bodies 830.

According to an embodiment, the operation of the tool 80 provides a clamping action with more force than traditional pliers. In addition, the tool 80 may clamp harder on the work piece when pulling force is applied to the shank 800. For example, when used in conjunction with a slide hammer, as discussed above, the pulling force may be substantially aligned with the center of the first and second jaw bodies 830 allowing the work piece to be removed with greater ease due to greater gripping force and slide hammer action.

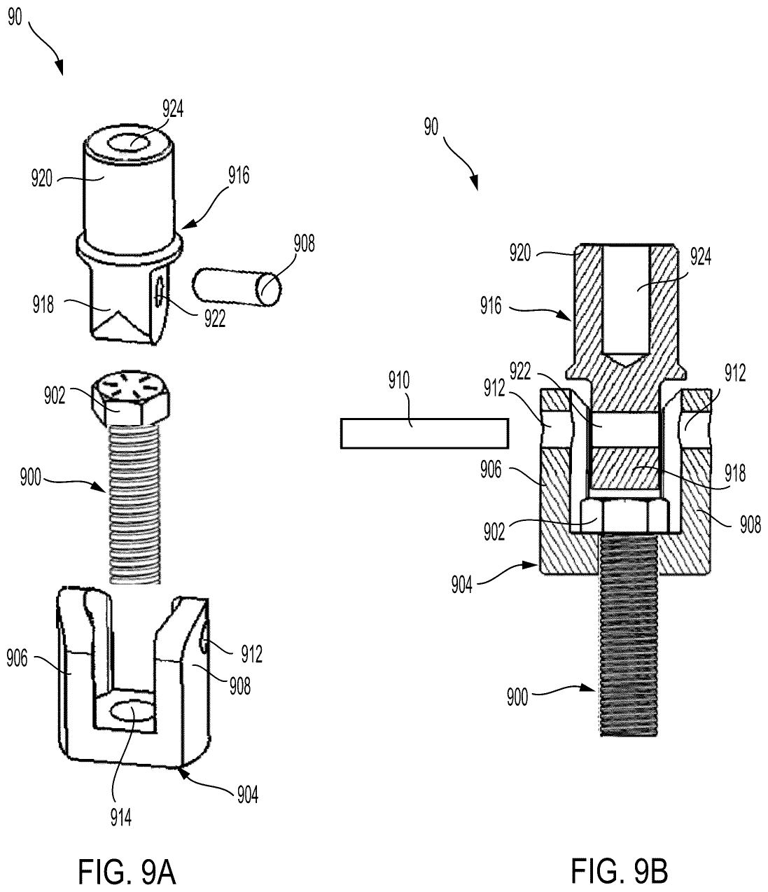

Referring generally to FIGS. 9A and 9B, an adaptor 90 is depicted according to an embodiment of the present invention. The adaptor 90 may be used with any of the embodiments described herein, including but not limited to slide hammer 100 and/or any of the tools 20, 30, 40, 50, 60, 70, 80 described above, or another tool. The adaptor 90 may be a universal swiveling device having a threaded shank 900, with a head 902 on the proximal end and the threaded shank 900 is adapted to couple to another tool. The head 902 is adapted to retain yoke 904, which may be disposed at or near the proximal end of the shank 900. The yoke 904 may include two opposing projections 906, 908, each with a yoke hole 912 adapted to receive a pin 910. The yoke 904 may include a threaded through hole 914. Alternatively, the through hole 914 may be not threaded, and may have a diameter greater than the outermost threads on the threaded shank 900.

The adapter 90 may also include a connector body 916. The connector body includes a first end 918 and second end 920, and an aperture 922 proximal to the first end 918, where the aperture 922 is adapted to receive pin 910 to pivotably couple the connector body 916 to the yoke 904. The first end 918 may have a rounded exterior surface to allow the connector body 916 to rotate relative to the yoke 904. The pin 910 may be sized and shaped to securely engage and be retained in the yoke holes 912 and the aperture 922, for example by press-fit or the like. Alternately, the pin 910 may be secured by threaded connection, ball detent, cotter pins, retaining snap-rings, or mushroom deformation (such as with a riveting operation). The second end 920 of the connector body 916 is adapted to couple to a slide hammer or another tool. In an embodiment, the second end 920 may include an opening 924 for coupling to another tool or another component. The other tool such as a slide hammer may be retained in the opening 924 by a press, friction or interference fit, threaded connection, ball detent, cotter pins, snap-rings, mushroom deformation (such as with a riveting operation) or the like. The opening 924 may be adapted for rotatable coupling to another tool such as a slide hammer, where the tool rotates relative to the adaptor about an axis of the opening 924.

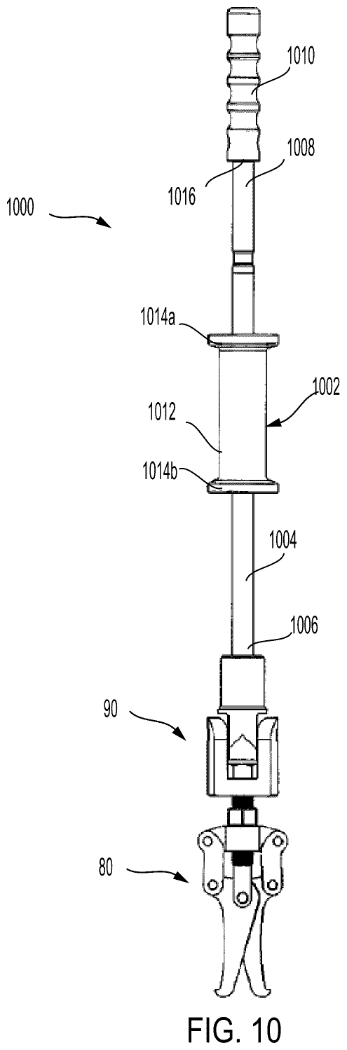

Referring generally to FIG. 10, a hammer slide 1000 is depicted, and the hammer slide 1000 is coupled to the adaptor 90, which is coupled to the tool 80, according to an embodiment of the present invention. The hammer slide 1000 may include a hammer body 1002 axially slidable along a longitudinal slide shaft 1004, such as, but not limited to, a metal rod. A first end 1006 of the shaft 1004 may serve as an attachment point for coupling the slide hammer assembly 1000 to an attachment, as described herein, or another object being worked upon, and may be threaded, beveled, male, female, or the like. While shown coupled to the adaptor 90 and tool 80, the hammer slide 1000 may be used with any of the embodiments described herein, including but not limited to any of the tools 20, 30, 40, 50, 60, 70, 80 described above, the adaptor 90, or another tool. A second end 1008 of the shaft 1004 may include or be coupled to a handle 1010.

The hammer body 1002 may include a through bore (not shown) extending longitudinally therethrough that slidably receives the slide shaft 1004. The through bore may have cross-sectional dimensions, orthogonal to the axis of the slide shaft 1004 and the hammer body 1002, slightly larger than the cross-sectional dimensions of the external “slide” surface of the slide shaft 1004, to allow the hammer body 1002 to be axially slidable on the slide shaft 1004.

The hammer body 1002 may have a middle section 1012, which is illustrated as cylindrical, but may have any cross-sectional configuration. The outer surface of the middle section 1012 may be ribbed, knurled, or textured to provide a griping or handhold portion. The hammer body 1002 may also have flanged ends 1014a, 1014b that extend radially outwardly and have a larger cross-section than the middle section 1012. The flanges 1014a, 1014b may help protect a user's hand and/or fingers when gripping the middle section 1014 to slide the hammer body 1002 along the shaft 1004.

A slide stop 1016 may be coupled to or integrally part of the shaft 1004, proximate to the second end 1008. The slide stop 1016 may have cross-sectional dimensions, orthogonal to the axis of the shaft 1004, larger than the cross-sectional dimensions of the through bore of the hammer body 1002. The hammer body 1002 may axially slide along the shaft 1004 in a direction until the hammer body 1002 impacts the slide stop 1016, producing an axial force, as described above with regard to FIG. 1.

While the embodiments of the tools described herein may be described as adapted to couple to a slide hammer, one skilled in the art will recognize that the tools described are not limited only to use with a slide hammer, but may be used with other tools, including but not limited to drivers, ratchets, extenders, or the like.

As used herein, words denoting approximations of ranges, such as “generally,” “substantially,” and “about,” are descriptive terms used to cover manufacturing tolerances. One of skill in the art would understand the disclosed and claimed dimensions and relationships do not have to be exact or precise, but some amount of tolerance (such as manufacturing and/or measuring tolerances) are within the scope of the claims and the invention.

As used herein, the term “coupled” and its functional equivalents are not intended to necessarily be limited to direct, mechanical coupling of two or more components. Instead, the term “coupled”, and its functional equivalents are intended to mean any direct or indirect mechanical, electrical, or chemical connection between two or more objects, features, work pieces, and/or environmental matter. “Coupled” is also intended to mean, in some examples, one object being integral with another object. As used herein, the term “a” or “one” may include one or more items unless specifically stated otherwise.

As used herein terms denoting direction, order, or orientation such as “first,” “second,” “horizontal,” “vertical,” “lateral,” “top,” “bottom,” “left,” “right,” “over,” “under,” “above,” “below,” “front,” back,” “proximal,” “distal,” “clockwise,” “counter-clockwise,” or the like, are non-limiting and used herein for ease of explanation. One of skill in the art will recognize the use of these terms as merely descriptive examples that do not limit the placement, orientation, or disposition of the elements described using such terms.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A tool comprising:
a base including a through hole;
first and second jaw bodies pivotably coupled to the base; and
a shank having distal and proximal ends, wherein the distal end is threadedly coupled to the base;
wherein rotation of the base with respect to the shank in a first rotational direction causes the first and second jaw bodies to pivot in a direction toward each other and rotation of the base in a second rotational direction causes the first and second jaw bodies to pivot in a direction away from each other.

2. The tool of claim 1, wherein the proximal end is adapted to couple to a slide hammer.

3. The tool of claim 2, wherein the proximal end includes a coupling adapted to couple to the slide hammer, and the coupling is shaped so it can engage a tool.

4. The tool of claim 1, wherein the first and second jaw bodies respectively include opposing first and second gripping jaws.

5. The tool of claim 4, wherein the opposing first and second gripping jaws face substantially away from each other and are adapted to engage an interior feature of a workpiece.

6. The tool of claim 1, wherein the first and second jaw bodies each include a workpiece-specific geometry adapted to cooperatively grip a work piece.

7. The tool of claim 1, further comprising a yoke coupled to the distal end of the shank, the first and second jaw bodies being pivotably coupled to the yoke.

8. The tool of claim 1, wherein each of the first and second jaw bodies are pivotably coupled to the base by one or more link bars.

9. The tool of claim 1, wherein the first jaw body is pivotably coupled to the base by first and second link bars and the second jaw body is pivotably coupled to the base by third and fourth link bars.

10. The tool of claim 1, further comprising a pad coupled to the distal end of the shank, wherein the rotation of the base in the second rotational direction causes the first and second jaw bodies to pivot about the yoke pin away from each other.

11. The tool of claim 10, wherein the pad includes a substantially conical wedge.

12. The tool of claim 1, wherein the first and second jaw bodies are substantially “L” shaped.

13. The tool of claim 1, wherein, the first and second jaw bodies are pivotably coupled to the base by one or more pins.

14. The tool of claim 1, wherein the base includes first and second wings, the first and second jaw bodies are respectively disposed in and pivotably coupled to the base at the first and second wings.

15. The tool of claim 1, further comprising an adaptor coupled to the base, wherein the adaptor comprises:
a yoke having an opening to receive the shank and first and second projections having respective first and second holes for receiving a pin, and
a connector body having an aperture for receiving the pin to pivotably couple the connector body to the yoke, wherein the connector body is adapted to couple to another tool.

16. A tool comprising:
a base defining a through hole and first and second wings;
a shank having distal and proximal ends, wherein the distal end is threadedly coupled to the through hole of the base;
a yoke coupled to the distal end of the shank; and
first and second jaw bodies, each jaw body having a clamping surface, wherein the first and second jaw bodies are pivotably coupled to the yoke by a yoke pin;
wherein rotation of the base with respect to the shank in a first rotational direction causes the first and second jaw bodies to pivot about the yoke pin in a clamping direction, and rotation of the base in a second rotational direction causes the first and second jaw bodies to pivot in an unclamping direction.

17. The tool of claim 16, wherein each of the first and second wings includes opposing first and second wing projections, the first jaw body is disposed between the first and second wing projections of the first wing, and the second jaw body is disposed between the first and second wing projections of the second wing.

18. The tool of claim 17, wherein each of the first and second wing projections includes a pin hole, a first pin is disposed in the pin holes of the first and second wing projections of the first wing, and a second pin is disposed in the pin holes of the first and second wing projections of the second wing.

19. The tool of claim 14, wherein the proximal end includes a coupling adapted to couple to a slide hammer, and the coupling is shaped to engage a tool.

20. A tool comprising:
a base defining a through hole and opposing first and second wings;
a shank having distal and proximal ends, wherein the distal end is threadedly coupled to the through hole of the base; and
first and second jaw bodies pivotably disposed between the first and second wings;
wherein rotation of the base with respect to the shank in a first rotational direction causes the first and second jaw bodies to pivot in a clamping direction, and rotation of the base in a second rotational direction causes the first and second jaw bodies to pivot in an unclamping direction.

21. The tool of claim 20, wherein each of the first and second wings includes first and second pin holes.

22. The tool of claim 21, further comprising a first pin disposed in the first pin holes of the first and second wings, and a second pin disposed in the second pin holes of the first and second wings.

23. The tool of claim 20, wherein the proximal end includes a coupling adapted to couple to a slide hammer, and the coupling is shaped to engage a tool.

24. A tool adapter comprising:
a base having a first jaw and a pocket;
a second jaw pivotably coupled to the base, and including a foot portion disposed in the pocket; and
a shank threadedly coupled to the base, extending into the pocket, and adapted to engage the foot portion, wherein threading the shank in a first rotational direction causes the second jaw to pivot towards the first jaw, and threading the shank in a second rotational direction causes the second jaw to pivot away from the first jaw.

25. The tool adapter of claim 24, wherein the base includes a coupling mechanism opposite the first jaw and adapted to couple the tool adapter to a slide hammer.

26. The tool adapter of claim 24, wherein the shank is disposed in the base axially.

27. The tool adapter of claim 24, wherein the shank is disposed in the base perpendicularly to the base.

28. The tool adapter of claim 24, wherein the shank is a threaded fastener and includes a head that is shaped to engage a tool.
